(19) United States
(12) Patent Application Publication
(10) Pub. No.: US 2022/0194057 A1
(43) Pub. Date: Jun. 23, 2022

(54) SWITCHABLE LAMINATED GLAZING WITH IMPROVED BUS BAR

(71) Applicant: AGP America S.A., Ciudad de Panama (PA)

(72) Inventors: Mario Arturo MANNHEIM ASTETE, Lima (PE); Andres Fernando SARMIENTO SANTOS, Lima (PE); Andres MOSCOSO, Lima (PE); Charles Stephen VOELTZEL, Shelby Township, MI (US); Raghu K. PENDYALA, Lima (PE); Juan Felipe CASTRO LANDINEZ, Lima (PE)

(21) Appl. No.: 17/607,471

(22) PCT Filed: Apr. 30, 2020
(86) PCT No.: PCT/IB2020/054119

§ 371 Date: Oct. 29, 2021

Related U.S. Application Data
(60) Provisional application No. 62/840,560, filed on Apr. 30, 2019.

(51) Int. Cl. B32B 17/10; G02F 1/166; G02F 1/1679

(52) U.S. Cl. CPC B32B 17/10532; B32B 17/10036; B32B 17/10651; B32B 17/1022; B60J 1/001; G02F 1/166; G02F 1/1679; B32B 2605/006; B32B 17/10183

(57) ABSTRACT

A switchable laminated glazing with improved bus bar that solves the problem of inhomogeneities and reduce the cost of its fabrication by providing a laminated glazing that comprise a switchable layer (14) that has an active material sandwiched between two conductive coated plastic layers (8), at least two bus bars (20) in electrical contact with the respective conductive coated plastic layer (8), and at least two pliable conductive media (12), each of them between the respective coated plastic layer (8) and bus bar (20). The area covered by pliable conductive medias (12) is substantially less than the area covered by bus bars (20). The invention provides an improved lower cost bus bar by sparing use of a pliable conductive media and by using a pliable conductive media in different kind of configurations.

### FIELD OF THE INVENTION

This invention relates to the field of switchable automotive laminates.

### BACKGROUND OF THE INVENTION

As automotive manufacturers work to meet government regulations for fuel efficiency and emissions, as well as to provide the type of environmentally friendly vehicles that the public is increasingly demanding, reducing weight has been a key strategy. While substituting lighter weight materials has been a big part of the trend, we have also seen a reduction in the average size of most vehicles. As the cabin volume decreases, it can lead to an unpleasant claustrophobic effect. To counter this, manufacturers have been increasing the glazed area of vehicles for several years. The increased viewing area and natural light helps to give the cabin an open and airier feel.

However, solar control and maintaining a comfortable lighting level can be difficult with this increased glass area especially on vehicles equipped with panoramic windshields and roofs.

A panoramic windshield is a windshield on which the top edge has been substantially extended such that it comprises a portion of the vehicle roof.

A panoramic roof is a vehicle roof glazing which comprises a substantial area of the roof over at least a portion of both the front and rear seating areas of the vehicle. A panoramic roof may be comprised of a single or multiple glazings and may be laminated or monolithic.

To control the level of light transmittance, there are many technologies available: electrochromic, photochromic, thermochromic and electric field sensitive films which are designed to be incorporated into laminated glass.

These technologies allow the intensity of light to be controlled by the occupants of the vehicle.

The technologies addressed by the immediate invention are suspended particle devices (SPD) films and polymer dispensed liquid crystal (PDLC) films which can quickly change their light transmittance in response to an electrical field.

SPD is a variable tint technology with which the level of tint can be controlled and varied in response to an applied electrical field. SPD goes from dark in the off state to less dark in the on state. In a SPD film, microscopic droplets of liquid containing needle like particles, light vales, are suspended in a matrix. In the off state the particles are in a random state of alignment and block the transmission of light. The degree of alignment and resulting tint can be varied in response to the applied voltage. The light transmittance in the on and off states can also be shifted through changes to the thickness and composition of the active material. In the off state, it is still possible to see clearly through SPD.

PDLC is a light scattering technology which goes from opaque in the off state to clear in the on state. In a PDLC film, microscopic droplets of liquid crystal are suspended in a polymer matrix. In the off state the liquid crystals are in a random state of alignment and scatter the light providing privacy. In the off state, the film is substantially opaque. When an electric field is applied, the crystals align and allow light to pass. The degree of scattering can be varied by varying the amplitude of the applied voltage. The level of light transmittance in the on and off states can also be shifted by making changes to the thickness and composition of the active material. PDLC is primarily a privacy product though it can also be used for solar control as it reduces the solar energy transmitted.

Both SPD and PDLC glazing are produced by adding a special film to a laminate. The typical construction of the film is comprised of an emulsion layer, containing the active material, sandwiched between two thin plastic layers having a transparent conductive oxide (TCO) coating on each. The film is laminated in between two plastic bonding interlayers to form a laminated glazing.

As mentioned, both SPD and PDLC films have in common a thin active emulsion layer sandwiched between a set of thin TCO coated plastic layers (typically PET). Indium Tin Oxide is a commonly used TCO. These coated plastic layers constitute electrodes. Electrodes are connected to a voltage source through bus bars. The purpose of bus bars is to conduct the current in the surface of electrodes as evenly possible. A bus bar is a metallic foil that might comprise one or more layers of a conductive material.

Both SPD and PDLC can be manufactured on the same type of equipment. The film is produced in sheets of standard width. The desired shape, for the glazing being fabricated, is cut from the standard sheet. As a result, the bus bars must be applied after the film has been cut to size and after fabrication of the film.

Due to the relatively high resistance of the TCO and the often occurrence of inhomogeneity in transparency of the active film, opposite bus bars with the total length of opposite edges of the film are often needed to provide for uniform voltage and switching along the length and width of the glazing.

Thin copper strips are typically used for the bus bars. However, the TCO coating can be difficult to make a good electrical connection too. At the microscopic level, the surface of the TCO is very rough and filled with cracks. Just placing the copper strip in contact with the coating will not suffice. A poor connection is made in this manner which will not work reliably.

To apply the bus bars to each TCO coated sheet, the opposite sheets are first cut back exposing the active material layer and the area where the bus bar will be applied. Typically bus bars are applied to opposite edges of the film. While they can be applied to the same edge, they may never overlap.

The exposed active layer is then removed, and the exposed TCO coating cleaned. What has typically been recommended by the SPD and PDLC film manufacturers, and used in the industry, is to apply a pliable conductive media, which make good electrical contact with the TCO, between the bus bar and the TCO. By pliable what is meant is a media with a viscosity sufficient to allow the media to substantially fill the microscopic surface defects in the TCO layer. This will generally be a liquid but could also be a solid with that will flow under temperature or pressure applied during the autoclave processing of the laminate. A silver paste or ink, originally developed and used for creating pliable conductive vias in circuit boards, is commonly used to facilitate the electrical connection. The paste used is comprised of small particles of silver suspended in a binder and carrier. The paste is applied directly over the conductive coating (TCO) via some manual or automated process (screen printing, jetting, inkjet, dispensing, among others). Then, it is dried and cured via thermal or UV process as hot air, oven, IR lamp, laser curing, or, UV-Lasers. The bus bar is applied over the dried silver. The copper strip may be applied directly to the silver or a conductive adhesive may be used to bond the copper strip to the silver. A conductive adhesive also serves to adhere the bus bar to the film. If a conductive adhesive is not used, then tape is generally applied over the bus bar to hold it in place.

The primary drawbacks of this method are the high cost of the silver paste and the time that it takes for the silver paste to dry. A relatively large amount of silver paste is required as the bus bars must often extend across the entire or a substantial portion of the length of the film. Even though the current flow if low, the voltage drop across the bus bars must be minimized as the transmittance state of the film is dependent upon the voltage of the electrical field.

In this sense, it would be desirable to provide a switchable laminated glazing with improved bus bar in a way that reduces or eliminates the problems described above.

### BRIEF SUMMARY OF THE INVENTION

It is an object of the present invention to provide a switchable laminated glazing with improved bus bar that solves the problem of inhomogeneities and reduce the cost of its fabrication.

This object can be attained by providing a laminated glazing that comprise a switchable layer that has an active material sandwiched between two conductive coated plastic layers, the coated surfaces of the plastic layers are in contact with the active material. Also comprise at least two bus bars, each bus bar is in electrical contact with the respective conductive coated plastic layer. Also comprise at least two pliable conductive media, each pliable conductive media is located between the coated surface of the respective conductive coated plastic layer and its corresponding bus bar. The area covered by pliable conductive medias is substantially less than the area covered by bus bars.

There is little actual real current flow in an SPD or PDLC film. The transparent conductive coating (TCO) is used to provide an electrical field which the active molecules of the film kinetically respond to. While typical power is in the 5-15 watts per square meter range, DC resistance is in the mega-ohms, so all the power is reactive. Typically, a pliable conductive media, such as the silver paste, is applied to at least the entire area covered by the bus bar. Experimental results show the surprising fact that the pliable conductive media may be printed or otherwise applied along as little as 1% of the bus bar area to achieve the same switching speed, light transmittance and haze. In addition to reducing the quantity of material needed, the invention also reduces labor, curing time and makes automation easier.

The pliable conductive media may be applied in a continuous line of a width that is less than the width of the bus bar or it may be discontinuous with the media printed at intervals. The spacing between may be uniform or non-uniform without departing from the intent of the invention.

The cuts in the switchable film where the bus bars would be fitted might cover totally or partially the perimeter of the film. The configuration of bus bars could be a straight line, L-shaped, U-shaped, among others. The configuration would be according to the desired voltage distribution in the film to improve optical properties. The pliable conductive media might adopt the configuration of its corresponding bus bar.

The bus bar might utilize a conductive adhesive to bond the bus bar to the pliable conductive media or the bus bar may be placed in direct contact to the pliable conductive media using tape over the bus bar to secure the bus bar to the film. A conductive epoxy or similar liquid adhesive can alternately be used in place of the pliable conductive media in which case, the adhesive will bond the bus bar to the film and make the electrical connection to the TCO.

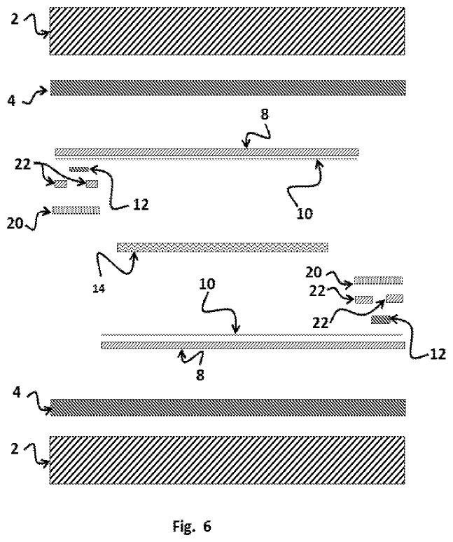

The thickness of the pliable conductive media may have a detrimental effect on the final assembled laminate leading to distortion, residual stress and arcing. To overcome these limitations, the bus bar is applied with a portion of the conductive adhesive at least partially removed in the areas overlapping the pliable conductive media such that the thickness of the final laminate is substantially the same across the bus bar. In this manner, the separation distance between the TCO and the bus bar is maintained at substantially the same distance. A cross section is shown in FIG. 6.

A flexible printed circuit (FPC) connects the external voltage source with bus bars. An area of the FPC might be located between the pliable conductive media and bus bar. FPC might be in contact with the pliable conductive media through conductive adhesive means such as Pressure Sensitive Adhesive (PSA). On the top of FPC, the bus bar is applied.

The switchable layer is laminated between PVB. To protect the integrity of the electrically conductive materials, a sealing material might cover the edges of the film. The sealing material could be polyethylene (PE), polystyrene (PS) or polyethylene terephthalate (PET). More preferably, the sealing material covers the edges of the switchable layer that corresponds to the bus bar area in the film.

As can be noted, by using a pliable conductive media in different kind of configurations, a switchable laminated glazing with improved optical properties (homogeneity) is obtained. Also, by using less quantity of material than is typically used, it can be obtained a cost reduction on switchable laminated glazing fabrication without compromising the electrical performance.

Benefits:
Reduction in cost.
Reduction in processing time.
Reduction in material.
Reduction in labor.
Facilitates automation of the process.
Protection of conductive materials

### BRIEF DESCRIPTION OF THE SEVERAL VIEWS OF THE DRAWINGS

| | |
|---|---|
| 1 | Cross Section |
| 2 | Exploded Cross Section: full conductive adhesive. |
| 3 | Panoramic Roof: Exploded View |
| 4 | Film: Exploded View |
| 5 | Film: Exploded View |
| 6 | Exploded Cross Section: partial conductive adhesive. |

### REFERENCE NUMERALS OF DRAWINGS

| | |
|---|---|
| 2 | Glass |
| 4 | Bonding/Adhesive Layer (interlayer) |
| 6 | Obscuration/Black Frit |
| 8 | Plastic (PET) |
| 10 | TCO Coating |
| 12 | Pliable Conductive Media (Silver Paste) |
| 14 | Active Material Layer (Emulsion) |
| 20 | Bus Bar |
| 22 | Conductive Adhesive |
| 28 | Switchable Film |

### Detailed Description of the Invention

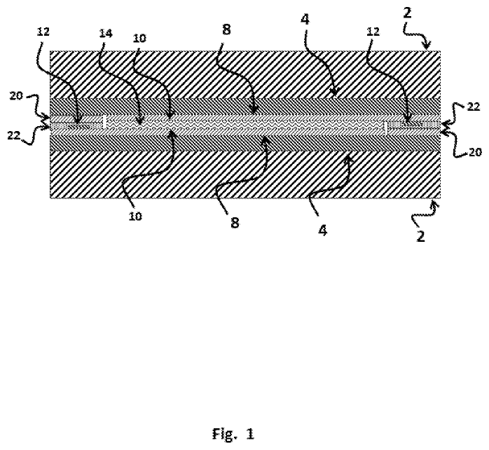

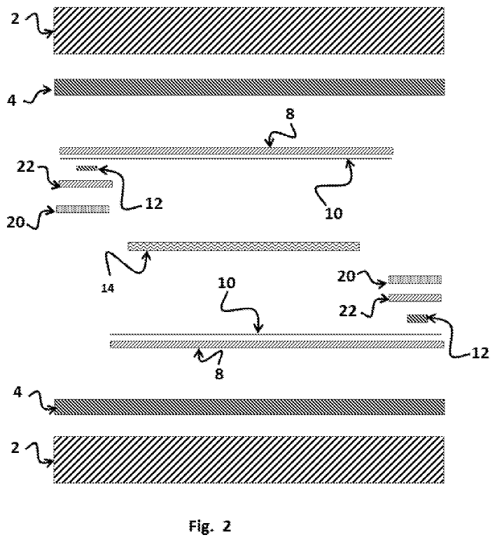

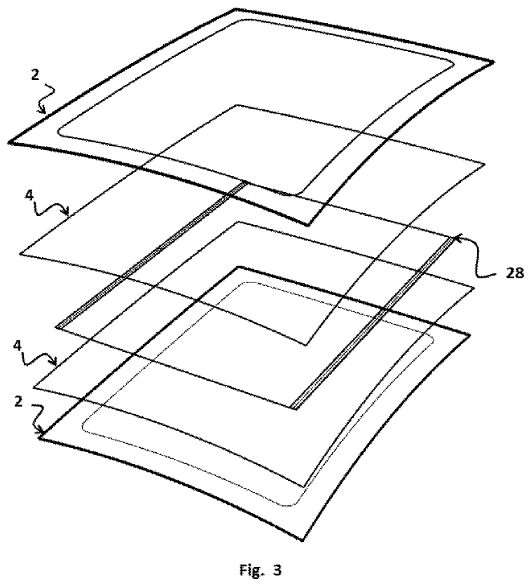

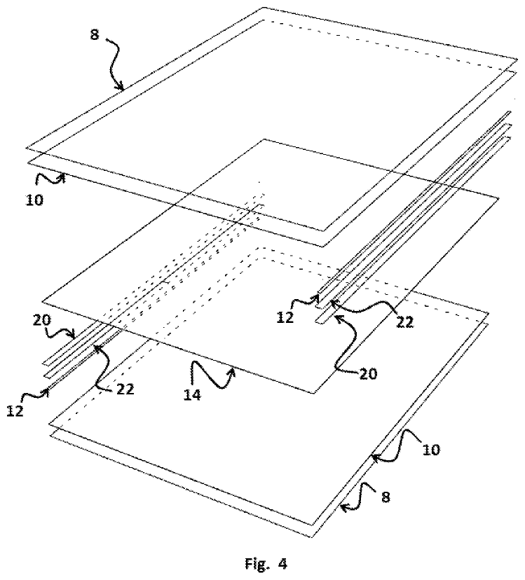

Embodiment 1: A laminated switchable panoramic roof (FIG. 3) is comprised of two 2.4 mm layers of solar green soda-lime glass 2. Two sheets of gray bonding interlayer 4 are used to bond a single sheet of switchable film (SPD film) 28 to the glass layers 2. The total visible light transmission of the laminate in the on state is 5%, in the off state, 27%. Along each long edge, one edge of each TCO coated layer 10 is cut back 12 mm along the entire length. The cut backs are made on opposite surfaces and sides. The cut back exposes the active material layer. The active material is scraped off with a plastic scraper. The surface is then cleaned using a solvent such as alcohol, hexane, heptane, among others. As shown in FIG. 4, a continuous 3 mm wide line is then printed directly onto the TCO surface 10, 6 mm inboard from the edge using a pliable conductive material (silver via paste) 12. The pliable conductive material (silver via paste) 12 is dried using a hot air blower or any other suitable means such as IR lamps, UV lamps or laser. A 6 mm wide strip of 2 oz. copper Bus bar 20 with a backing of 50 μm conductive adhesive 22 is then adhered to the exposed TCO 10 and pliable conductive material (silver via paste) 12, centering it with the cut back.

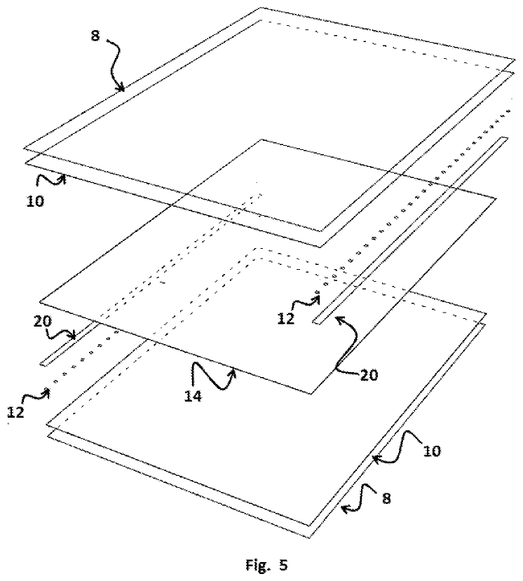

Embodiment 2: This embodiment is the same as embodiment 1 with the exception of the silver via print. 3 mm diameter circles are printed every 25 mm along the edge (such as the ones shown in FIG. 5).

Embodiment 3: This embodiment is the same as embodiment 1 with the exception of the silver via print. A 1.5 mm continuous line of silver via paste 12 is printed along the length of the cut back and centered with the cut back.

Embodiment 4: This embodiment is the same as embodiments 1 to 3 but without the conductive adhesive. The copper bus bar is placed directly in contact with the pliable conductive media (silver via print) and the TCO coating, such the cooper bus bar shown in FIG. 5.

Embodiment 5: This embodiment is the same as embodiments 1 to 3 but with the conductive adhesive 22 applied along the length of the copper bus bar 20 in two 2 mm wide separate strips on either side of the 3 mm pliable conductive media 12 such that the conductive adhesive 22 only partially overlaps the pliable conductive media 12. The copper bus bar 20 is placed in contact with the pliable conductive media (silver via print) 12, such the cooper bus bar shown in FIG. 6.

Embodiment 6: A laminated switchable panoramic roof (FIG. 3) is comprised of two 2.4 mm layers of solar green soda-lime glass 2. Two sheets of gray interlayer 4 are used to bond a single sheet of switchable layer (SPD film) 28 to the glass layers 2. The total visible light transmission of the laminate in the on state is 5%, in the off state, 27%. Along each long edge, one edge of each TCO coated layer 10 is cut back in a range of 5 mm-15 mm along the entire length. The cut backs are made on opposite surfaces and sides. The cut back exposes the active material layer. The active material is scraped off with a plastic scraper. The surface is then cleaned using a solvent such as alcohol, hexane, heptane, among others. As shown in FIG. 4, a continuous 3 mm wide line is then printed directly onto the TCO surface 10, 6 mm inboard from the edge using a pliable conductive media (silver via paste) 12. The pliable conductive media (silver via paste) 12 is dried using a hot air blower or any other suitable means such as IR lamps, UV lamps or laser. A 6 mm wide strip of 2 oz. copper Bus bar 20 with a backing of 50 μm conductive adhesive 22 is then adhered to the exposed TCO 10 and conductive media (silver via paste) 12, centering it with the cut back.

What is claimed is:

1. A switchable laminated glazing comprising:
at least one switchable layer;
at least two bus bars;
at least two pliable conductive media;
wherein the at least one switchable layer has an active material sandwiched between two conductive coated plastic layers, being the coated surfaces in contact with the active material;
wherein each of the at least two bus bars is in electrical contact with a coated surface of the respective conductive coated plastic layer;
wherein each of the at least two pliable conductive media is located between the coated surface of the respective conductive coated plastic layer and its corresponding bus bar;
wherein the area covered by each of the at least two pliable conductive media is substantially less than the area covered by its corresponding bus bar.

2. The switchable laminated glazing of claim 1, wherein the pliable conductive media is comprised of metallic particles suspended in a liquid.

3. The switchable laminated glazing of claim 1, wherein the pliable conductive media forms a discontinuous trace.

4. The switchable laminated glazing of claim 1, wherein the pliable conductive media forms a continuous trace.

5. The switchable laminated glazing of claim 1, wherein the bus bar has a configuration selected from the group of straight line, L-shaped and U-shaped.

6. The switchable laminated glazing of claim 1, wherein a conductive adhesive is used to bond the bus bar to the pliable conductive media.

7. The switchable laminated glazing of claim 6, wherein the conductive adhesive partially overlaps the pliable conductive media.

8. The switchable laminated glazing of claim 1, wherein a tape over the bus bar is used to secure the bus bar to the film.

9. The switchable laminated glazing of claim 1, where in a flexible printed circuit (FPC) is located between the pliable conductive media and the bus bar, and is in contact with the pliable conductive media through conductive adhesive means.

10. The switchable laminated glazing of claim 1, wherein a sealing material covers the edges of the at least one switchable layer.
